(19) United States
(12) Patent Application Publication
(10) Pub. No.: US 2014/0091040 A1
(43) Pub. Date: Apr. 3, 2014

(54) BICARBONATE CONVERSION ASSISTED RO TREATMENT SYSTEM FOR NATURAL GAS FLOWBACK WATER

(71) Applicants: John R. Herron, Corvallis, OR (US); Edward Beaudry, Corvallis, OR (US); Keith Lampi, Corvallis, OR (US); Sherwin Gormly, Carson City, NV (US)

(72) Inventors: John R. Herron, Corvallis, OR (US); Edward Beaudry, Corvallis, OR (US); Keith Lampi, Corvallis, OR (US); Sherwin Gormly, Carson City, NV (US)

(73) Assignee: HYDRATION SYSTEMS, LLC, Scottsdale, AZ (US)

(21) Appl. No.: 14/005,957

(22) PCT Filed: Mar. 16, 2012
(86) PCT No.: PCT/US12/29561

§ 371 Date: Oct. 22, 2013

Related U.S. Application Data
(60) Provisional application No. 61/454,174, filed on Mar. 18, 2011.

(51) Int. Cl. C02F 9/00

(52) U.S. Cl. CPC C02F 9/00
USPC 210/638; 210/639; 210/202

(57) ABSTRACT

Bicarbonate conversion assisted reverse-osmosis (RO) treatment systems for treatment of contaminated water, particularly natural gas flowback water. The systems and processes provide for simultaneous conversion of the primary salt in gas production flowback waters from sodium bicarbonate to sodium sulfate, and flotation removal of organic contaminants, for the enhanced water recovery by RO of these waters. In the systems and processes, RO processes are enhanced by lowering the osmotic potential of the water being processed, by converting the bicarbonate ions to sulfate ions.

### RELATED APPLICATION DATA

This application claims priority to U.S. Provisional Patent Application No. 61/454,174 filed on Mar. 18, 2011.

### FIELD OF THE INVENTION

This invention relates to systems and processes for treating so-called flowback waters resulting from the production of natural gas.

### BACKGROUND OF THE INVENTION

Natural gas flowback water is deep groundwater that is entrained in natural gas and released at the gas wellhead. This water is generally extremely high in toxic organic contaminants, and is also often a high strength brine (salt water), due to the gas bearing geological formations that are the source of the gas. This water is generally extremely difficult to treat and can be a significant environmental liability associated with gas production. Currently, flowback water is treated by either direct evaporative boiling or by a major flocculation, flushing, precipitation, filtration, and RO treatment process.

### SUMMARY OF THE INVENTION

Bicarbonate conversion assisted reverse-osmosis (RO) treatment systems for treatment of contaminated water, particularly natural gas flowback water are described herein. The systems and processes provide for simultaneous conversion of the primary salt in gas production flowback waters from sodium bicarbonate to sodium sulfate, and flotation removal of organic contaminants, for the enhanced water recovery by RO of these waters. In the systems and processes, RO processes are enhanced by lowering the osmotic potential of the water being processed, by converting the bicarbonate ions to sulfate.

### BRIEF DESCRIPTION OF THE DRAWING

FIG. 1 is a schematic diagram illustrating an exemplary embodiment of the system and process of the invention.

### DETAILED DESCRIPTION OF THE INVENTION

Different flowback waters from different geological formations (e.g., old carbonate or serpentine rock formations) or regions provide interesting and unique opportunities for remediation and recovery. The system and process of the invention may be used to remove carbonate-containing compounds, such as sodium bicarbonate and potassium bicarbonate, from flowback water.

The gas production flowback waters in certain areas (for example, particularly in southeastern Australia) can be extremely high in sodium bicarbonate (NaHCO₃) rather than the more common sodium chloride (NaCl) salts.

The process of the invention involves the addition of sulfuric acid (H₂SO₄) to the flowback water to convert the flowback water's primary salts, or total dissolved solids (TDS) content, from NaHCO₃ to sodium sulfate (Na₂SO₄).

System implementations simultaneously convert the primary salt in gas production flowback waters from sodium bicarbonate to sodium sulfate and remove the organics via flotation separation, thereby providing for the enhanced water recovery by RO of these waters. The conversion of the bicarbonate to the sulfate decreases the osmotic pressure of the flowback water by about half so that RO treatment of it gives you about twice as much product water than if the bicarbonates were left in prior to RO treatment.

The system and process of the invention provides a way to obtain a significantly high percentage recovery of the flowback water fed into the system. Moreover, the system and process of the invention eliminates the fouling and need to clean the RO portion of the system, by relatively easily removing organic contaminants prior to subjecting to RO.

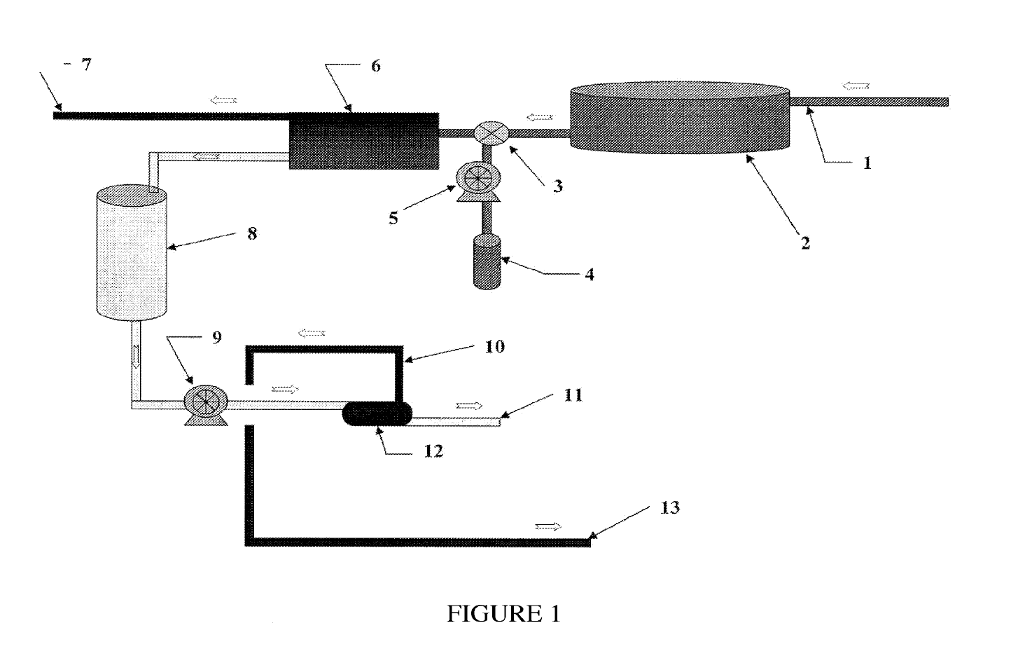

The process of the invention is described below in relation to FIG. 1, which illustrates an exemplary embodiment of a system according to the invention.

As shown in FIG. 1, the system comprises a well flowback input line 1 through which flowback water having a high sodium bicarbonate content (and low NaCl content) enters the system. Preferably, the flowback water may be stored in a tank or other suitable storage device 2.

Flowback water from the tank 2 is then treated with sulfuric acid (H₂SO₄). The sulfuric acid may be stored in an addition tank 4, and may be added to the flowback water via a three-way mixing valve 3. Illustrated is a pump 5 for pumping sulfuric acid to the valve 3. The sodium bicarbonate (NaHCO₃) and the sulfuric acid (H₂SO₄) react to form sodium sulfate (Na₂SO₄), releasing carbon dioxide (CO₂) in the process.

Preferably, the sulfuric acid (H₂SO₄) is added to the flowback water in the flotation separation unit 6. The sulfuric acid may advantageously be added at or through the bottom of the unit 6. Alternatively, the sulfuric acid may be added to the flowback water as it travels to the flotation separation unit 6. The flotation separation unit is preferably a dissolved air filtration (DAF) unit. In this unit 6, carbon dioxide produced by the reaction of the sodium bicarbonate (NaHCO₃) and the sulfuric acid (H₂SO₄) assists in separating the organic contaminants from the sodium sulfate (Na₂SO₄)-dominated brine. The organic contaminants tend to float to the surface of the liquid in unit 6, assisted by the bubbling of the carbon dioxide that has been produced. Optionally, as needed, the function of the flotation separation unit could be enhanced by bubbling additional gas (i.e., gas not produced by the reaction of the sodium bicarbonate in the flowback water).

The organic contaminants that are at the surface of the liquid in unit 6 form a first stream 7 that is removed from the system and disposed of. Alternatively, the system may be provided with additional devices to further process the organic contaminant stream.

The Na₂SO₄-dominated brine is in a second stream which then flows or is otherwise transferred to a clarified brine tank 8. Thereafter, the Na₂SO₄-dominated brine flows or is otherwise transferred, preferably by pumping via pump 9, to an RO system 12, wherein the brine is subjected to RO treatment. Product water that has been treated by the process of the invention flows or is otherwise transferred via line 11.

Brine rejected from the RO system 12 flows or is otherwise transferred via line 10, and may be optionally treated after leaving line 13, such as by dewatering/crystallization.

Initially, natural gas flowback water from the gas wellhead that is high in sodium bicarbonate (NaHCO₃), rather than the more common sodium chloride (NaCl) salts, is pumped into a storage tank prior to treatment. The flowback water is at ambient pressure.

Then, sulfuric acid (H₂SO₄) is added to the flowback water, such as using a three-way mixing valve as shown in FIG. 1, to convert the flowback water's primary salts, or total dissolved solids (TDS) content, from NaHCO₃ to sodium sulfate (Na₂SO₄). Preferably, sulfuric acid is added to reduce the pH of the mixture to between about 3 and about 5. CO₂ is released out of solution and is then used for driving dissolved air flotation (DAF) separation of the organic contaminants in the flowback water in a flotation/separation tank.

The separated organic contaminants are diverted to the RO reject brine tank. The remaining Na₂SO₄-dominated, flotation-clarified brine is then directed to the clarified brine tank 8 and drawn into the RO loop (9, 10, 12).

For the recovery of water then, the clarified brine is pumped under pressure to the RO elements where it is re-concentrated, and the clean product water is simultaneously produced. This completes the recovery of wastewater to high-grade reuse water. In southeast Australia about 60% to 70% of the flowback water can be recaptured instead of being evaporated.

A variety of different RO systems can be utilized in the process and system of the invention, depending upon the desired quality of the product water.

The RO reject brine is then pumped out of the system for final dewatering and crystallization. This reject brine represents about 30% to 40% of the total flowback water.

Thus, as described, the gas production flowback waters in certain areas (particularly in South Eastern Australia) are extremely high in sodium bicarbonate (NaHCO₃), rather than the more common sodium chloride (NaCl) salts. This provides the opportunity to add sulfuric acid (H₂SO₄) and convert the flowback water's primary salts, or total dissolved solids (TDS) content, from NaHCO₃ to Na₂SO₄ (sodium sulfate) (essentially use wet chemistry and an endothermic reaction that runs itself to reduce cut ionic strength in half). This has two effects that can then be directly harnessed for treatment.

One, CO₂ is released out of solution. This CO₂ will come out of solution initially in extremely small, but quickly accumulating and growing, bubbles that can then be used for driving dissolved air flotation (DAF) separation of the organics in the flowback water. Traditional DAF requires large energy inputs to pressurize air (60 to 80 psi) that is then released to create the DAF flotation effect (to force air in solution). Here, however, the release of CO₂ from solution (release of carbonation) provides a stronger than normal DAF effect (drives DAF) with no need to pressurize air (i.e., DAF occurs at ambient pressure) and thus no energy input (there is a fundamental energy savings because of the chemical energy that is able to be used from the sulfuric acid to carbonate reaction), This will provide excellent organic removal from the flowback water at low cost and with low energy input.

Two, the resulting salt in the water (Na₂SO₄) following sulfuric acid addition and CO₂ loss allows for far higher water recoveries in membrane desalination than the original salt. Membrane concentration of salts is limited by the osmotic strength of the brines, so that for a given applied pressure, water can only be removed from the brine up to a point where the osmotic strength of the brine equals the applied pressure. An advantage of acidifying with sodium sulfate that is it has roughly half the osmotic potential of the original carbonate system salts, and thus will allow twice the water recovery for the same energy/pressure input into a membrane desalination system.

The water recovery is further enhanced because membranes exist which block the passage of sulfate salts while allowing the passage of chloride salts. An example of such a membrane is the Dow SR90. If this membrane is used as the first desalinator, it will produce a solution where the osmotic pressure of the sodium sulfate alone approaches the applied pressure. The permeate from this membrane will have no sodium sulfate and the original concentration of sodium chloride. The permeate can then be concentrated with a high pressure RO system to a concentration approaching the applied pressure.

As an example, it will be assumed that the flowback water is 0.4 M in sodium bicarbonate and 0.2 M in sodium chloride. If this was desalinated with a high-pressure RO system, the brine could be concentrated to a combined 1.2 M (0.8 sodium bicarbonate and 0.4 sodium chloride) for a net water removal of 50%.

If the flowback water is fully acidified with sulfuric acid, the molarities become 0.2 M sodium sulfate and 0.2 M sodium chloride, so if the water is fed to a high pressure RO the solution can be concentrated to a combined 1.2 M, which allows a 67% water removal.

If instead the acidified feed is first concentrated by a high pressure sulfate retaining nanofiltration membrane, every six units of feed will be separated into 1 unit of retentate with 1.2 M sodium sulfate and 0.2 M sodium chloride, and 5 units of permeate with 0.2 M sodium chloride. The permeate can then be concentrated to 1.2 M which gives a total water removal of 70%, as well as distinct brine streams of enriched sodium sulfate and largely pure sodium chloride.

This, in combination with the lowered membrane fouling potential resulting from the DAF treatment effect, will render these flowback waters easily treatable by reverse osmosis (RO), where previously this would be prohibited based on fouling, scaling, and high osmotic potential. The synergistic effects result in this process allowing high-grade membrane treatment of flowback water, at low energy input, for a water stream that would otherwise be untreatable by membrane processes.

Specifications, Materials, Manufacture, Assembly

In places where the description above refers to particular implementations, it should be readily apparent that a number of modifications may be made without departing from the spirit thereof and that these implementations may be alternatively applied. This document is intended to cover such modifications as would fall within the true spirit and scope of the disclosure set forth in this document. The presently disclosed implementations are, therefore, to be considered in all respects as illustrative and not restrictive.

It will be understood that implementations are not limited to the specific components disclosed herein, as virtually any components consistent with the intended operation of a bicarbonate conversion assisted RO treatment system may be utilized. Accordingly, for example, although particular components and so forth, are disclosed, such components may comprise any shape, size, style, type, model, version, class, grade, measurement, concentration, material, weight, quantity, and/or the like consistent with the intended operation of a bicarbonate conversion assisted RO treatment implementation. Implementations are not limited to uses of any specific components, provided that the components selected are consistent with the intended operation of a bicarbonate conversion assisted RO treatment system implementation.

This synergistic bicarbonate conversion assisted RO treatment system and process is uniquely valuable to natural gas production and processing operations, and represents a significant potential advance in natural gas process technology. Current systems and processes are highly energy intensive when compared with the system and process of the invention.

1-7. (canceled)

8. A method for treating water having high sodium bicarbonate content to reduce its sodium bicarbonate content, comprising the following steps:
(a) adding sulfuric acid to the water;
(b) subjecting the water to flotation separation to produce a first stream of organic contaminants and a second stream of sodium sulfate-dominated clarified brine; and
(c) subjecting the second stream to reverse osmosis, to produce a stream of product water.

9. The method of claim 8, wherein step (a) comprises adding sulfuric acid to the water to reduce the water's pH to between about 3 and about 5.

10. The method of claim 8, wherein the flotation separation is dissolved air flotation separation.

11. The method of claim 10, wherein the dissolved air flotation separation is driven by carbon dioxide produced in step (a) from reaction of sodium bicarbonate and sulfuric acid.

12. The method of claim 10, wherein the dissolved air flotation separation is conducted at ambient pressure.

13. The method of claim 8, wherein step (c) further comprises producing a stream of reject brine, and the reject brine is subjected to at least one further treatment consisting of dewatering or crystallization.

14. The method of claim 8, wherein the water having high sodium bicarbonate content is natural gas flowback water.

15. The method of claim 14, wherein about 60% to about 70% of the flowback water is recovered as product water.

16. A method for improving recovery by reverse osmosis of water from natural gas flowback water having a high content of bicarbonate salts, comprising lowering osmotic potential of the flowback water by converting bicarbonate salts in the flowback water to sulfate based salts, and then subjecting the flowback water to reverse osmosis.

17. The method of claim 16, wherein the osmotic potential of the flowback water is lowered by about 50% and water recovery by reverse osmosis system is increased by about 50% over that projected based solely on initial salt concentrations in the water.

18. A system for improving water recovery from natural gas flowback water wherein the water has a high content of bicarbonate salts, comprising:
(a) apparatus for introducing sulfuric acid into a stream of natural gas flowback water;
(b) a flotation separation unit downstream of the apparatus for introducing sulfuric acid; and
(c) a reverse osmosis system downstream of the flotation separation unit.

19. A system for improving water recovery from natural gas flowback water wherein the water has a high content of bicarbonate salts, comprising:
(a) a mixing valve and a pump for introducing sulfuric acid into a stream of natural gas flowback water;
(b) a flotation separation unit downstream of the mixing valve and pump;
(c) a clarified brine tank for receiving a stream of flotation clarified brine from the flotation separation unit; and
(c) a reverse osmosis system downstream of the clarified brine tank.

20. The system of claim 19, further comprising a storage tank for the natural gas flowback water, wherein the storage tank is located upstream of the apparatus for introducing sulfuric acid.
